(19) United States
(12) Patent Application Publication
(10) Pub. No.: US 2007/0058926 A1
(43) Pub. Date: Mar. 15, 2007

(54) Optimizing trick modes for streaming media content

(75) Inventors: Gurpratap Virdi, Bellevue, WA (US); Todd Bowra, Redmond, WA (US); Jeffrey Davis, Snohomish, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/222,691

(22) Filed: Sep. 9, 2005

(51) Int. Cl. H04N 5/91; H04N 7/16

(52) U.S. Cl. 386/68; 725/151

(57) ABSTRACT

While streaming media content, trick mode operation is optimized to a level that can be readily accommodated by available resources of a media delivery system. In one possible strategy, a trick mode optimization module may decrease the bit rate of the media content stream by progressively dropping delta frames and then a fraction of the remaining key frames as needed. According to another possible strategy, the trick mode optimization module may decrease the bit rate of the media content by progressively dropping sequences of frames between successive key frames. In addition, the trick mode optimization module may combine strategies and drop sequences between key frames, as well as dropping delta frames from the remaining sequences.

### BACKGROUND

As the personal computer (PC) moves to become the center of the digital home, more consumers will be able to enjoy the PC's functionality as an entertainment server. In one popular implementation, consumers can stream a movie or a television program from their entertainment server over a home network to a home network device. In this way, consumers can render audio/video content on a video monitor in real-time with media transport functionality (i.e. the device may render the media content and the user may be afforded functions such as pause, play, and trick modes such as fast forward, seek, rewind, etc). Often, however, the media transport functionality may be limited by the capacity of the home network. For example, if a user wishes to fast forward a 2 Mbps stream of media content at 10 times normal playback speed, a network capacity of at least 20 Mbps will be required. As a result, the user's home network will need to have excessive capacity for the sole purpose of supporting trick modes in media streaming, which is both expensive and inefficient.

Thus, there exists a need to enable a PC to stream media content with media transport functionality over a network without requiring the network to have excessive capacity in order to facilitate trick mode operation.

### SUMMARY

While streaming media content, trick mode operation is optimized to a level that can be readily accommodated by available resources of a media delivery system. In one possible strategy, a trick mode optimization module may decrease the bit rate of the media content stream by progressively dropping delta frames and then a fraction of the remaining key frames as needed. According to another possible strategy, the trick mode optimization module may decrease the bit rate of the media content by progressively dropping sequences of frames between successive key frames. In addition, the trick mode optimization module may combine strategies and drop sequences between key frames, as well as dropping delta frames from the remaining sequences.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an exemplary home environment including an entertainment server, a home network device, and a home television.

FIG. 2 shows an exemplary architecture for streaming media content from a content source to a home network device using a trick mode optimization module.

FIG. 3 illustrates a block diagram of a trick mode optimization module being used in conjunction with an entertainment server communicatively coupled to a home network device.

FIG. 4 illustrates an unaltered stream of frames along with several streams of frames which have been altered by the trick mode optimization module.

FIG. 5 is a flow diagram illustrating a methodological implementation of a trick mode optimization module to avoid the creation of streaming bottlenecks.

FIG. 6 is a flow diagram illustrating a methodological implementation of a resource information manager to select a strategy to avoid the creation of a streaming bottleneck.

### DETAILED DESCRIPTION

### Home Environment

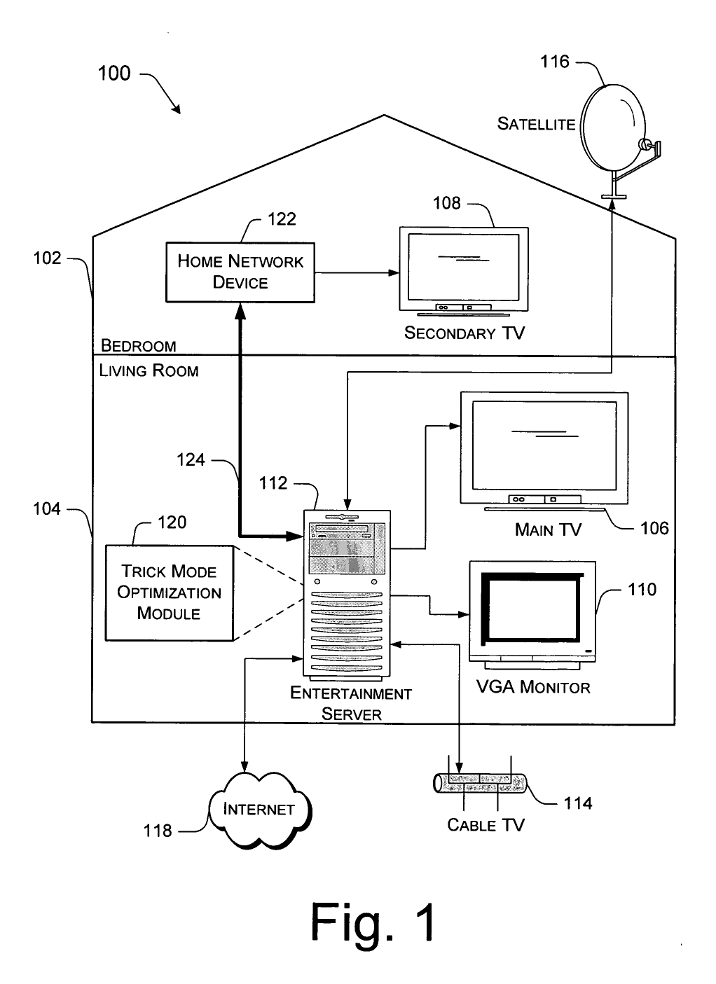

FIG. 1 shows an exemplary home environment 100 including a bedroom 102 and a living room 104. Situated throughout the home environment 100 are a plurality of monitors, such as a main TV 106, a secondary TV 108, and a VGA monitor 110. Content may be supplied to each of the monitors 106, 108, 110 over a home network from an entertainment server 112 situated in the living room 104. In one implementation, the entertainment server 112 is a conventional personal computer (PC) configured to run a multimedia software package like the Windows® XP Media Center edition operating system marketed by the Microsoft Corporation. In such a configuration, the entertainment server 112 is able to integrate full computing functionality with a complete home entertainment system into a single PC. For instance, a user can watch TV in one graphical window of one of the monitors 106, 108, 110 while sending email or working on a spreadsheet in another graphical window on the same monitor. In addition, the entertainment server 112 may also include other features, such as:
A Personal Video Recorder (PVR) to capture live TV shows for future viewing or to record the future broadcast of a single program or series.
DVD playback.
An integrated view of the user's recorded content, such as TV shows, songs, pictures, and home videos.
A 14-day EPG (Electronic Program Guide).

In addition to being a conventional PC, the entertainment server 112 could also comprise a variety of other devices capable of rendering a media component including, for example, a notebook or portable computer, a tablet PC, a workstation, a mainframe computer, a server, an Internet appliance, combinations thereof, and so on. It will also be understood, that the entertainment server 112 could be an entertainment device, such as a set-top box, capable of delivering media content to a computer where it may be streamed, or the entertainment device itself could stream the media content.

With the entertainment server 112, a user can watch and control a live stream of television or audio content received, for example, via cable 114, satellite 116, an antenna (not shown for the sake of graphic clarity), and/or a network such as the Internet 118. This capability is enabled by one or more tuners residing in the entertainment server 112. It will also be understood, however, that the one or more tuners may be located remote from the entertainment server 112 as well.

The entertainment server 112 may also receive media content from computer storage media such as a removable, non-volatile magnetic disk (e.g., a “floppy disk”), a non-volatile optical disk such as a CD-ROM, DVD-ROM, or other optical media, as well as other storage devices which may be coupled to the entertainment server 112.

Multi-channel output for speakers (not shown for the sake of graphic clarity) may also be enabled by the entertainment server 112. This may be accomplished through the use of digital interconnect outputs, such as Sony-Philips Digital Interface Format (SPDIF) or Toslink enabling the delivery of Dolby Digital, Digital theater Sound (DTS), or Pulse Code Modulation (PCM) surround decoding.

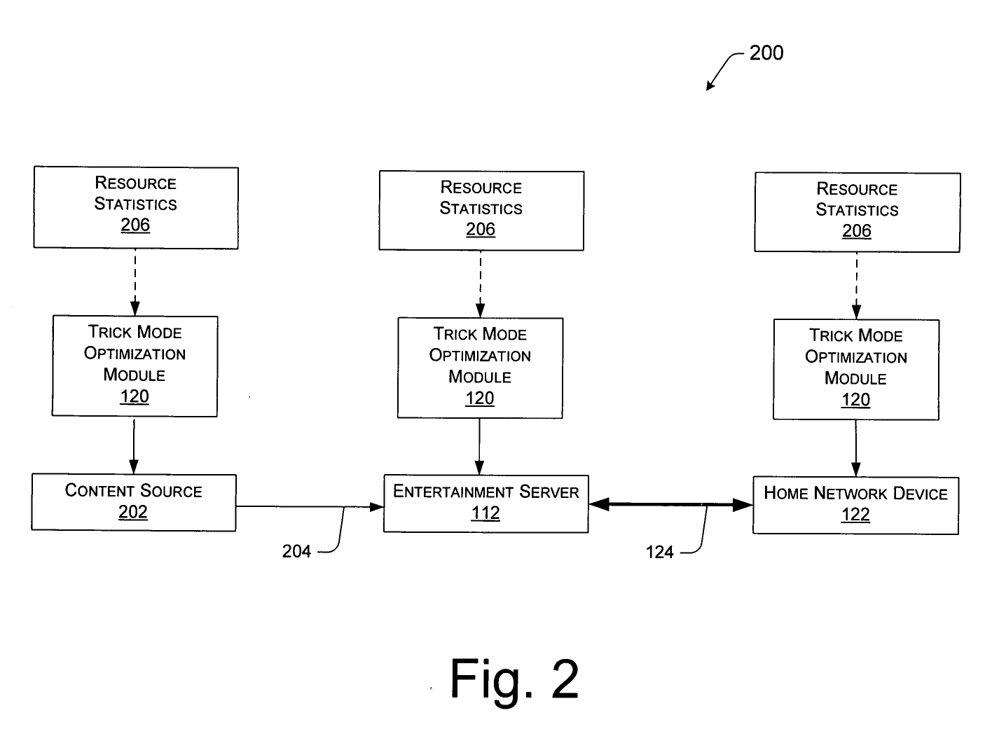

Additionally, the entertainment server 112 may include a trick mode optimization module 120 configured to allow a user to decrease the bit rate of media content being streamed during the activation of trick modes. The trick mode optimization module 120 accomplishes this by selectively dropping portions of the media content being streamed. The trick mode optimization module 120, and methods involving its use, will be described in more detail below in conjunction with FIGS. 2-6.

Since the entertainment server 112 may be a full function computer running an operating system, the user may also have the option of running standard computer programs (word processing, spreadsheets, etc.), sending and receiving emails, browsing the Internet, or performing other common functions.

The home environment 100 may also include a home network device 122 placed in communication with the entertainment server 112 through a network 124. Home network devices 122 may include Media Center Extender devices marketed by the Microsoft Corporation, Windows® Media Connect devices, game consoles, such as the Xbox game console marketed by the Microsoft Corporation, and devices which enable the entertainment server 112 to stream audio and/or video content to a monitor 106, 108, 110 or audio system. The home network device 122 may also be implemented as any of a variety of conventional computing devices, including, for example, a desktop PC, a notebook or portable computer, a workstation, a mainframe computer, an Internet appliance, a gaming console, a handheld PC, a cellular telephone or other wireless communications device, a personal digital assistant (PDA), a set-top box, a television, an audio tuner, combinations thereof, and so on.

The network 124 may comprise a wired, and/or wireless network, or any other electronic coupling means, including the Internet. It will be understood that the network 124 may enable communication between the home network device 122 and the entertainment server 112 through packet-based communication protocols, such as transmission control protocol (TCP), Internet protocol (IP), real time transport protocol (RTP), and real time transport control protocol (RTCP). The home network device 122 may also be coupled to the secondary TV 108 through wireless means or conventional cables.

The home network device 122 may be configured to receive a user experience stream (i.e. the system/application user interface, which may include graphics, buttons, controls and text) as well as a compressed, digital audio/video stream from the entertainment server 112. The user experience stream may be delivered in a variety of ways, including, for example, standard remote desktop protocol (RDP), graphics device interface (GDI), or hyper text markup language (HTML). The digital audio/video stream may comprise video IP, SD, and HD content, including video, audio and image files, decoded on the home network device 122 and then “mixed” with the user experience stream for output on the secondary TV 108. Media content may be delivered to the home network device 122 in formats such as MPEG-1, MPEG-2 and Windows Media Video (WMV).

In FIG. 1, only a single home network device 122 is shown. It will be understood, however, that a plurality of home network devices 122 and corresponding displays may be dispersed throughout the home environment 100, communicatively coupled to the entertainment server 112. It will also be understood that in addition to the home network device 122 and the monitors 106, 108, 110, the entertainment server 112 may be communicatively coupled to other output peripheral devices, including components such as a printer (not shown for the sake of graphic clarity).

### System With Trick Mode Optimization Module(s)

FIG. 2 shows an exemplary architecture of a media delivery system 200 suitable for delivering media content from a content source 202 via the entertainment server 112 to the home network device 122. The content source 202 may include removable/non-removable and volatile/non-volatile computer storage media. For example, the content source 202 could include non-removable, non-volatile magnetic media such as a hard disk; removable, non-volatile magnetic media such as a floppy disk; and a removable, non-volatile optical disk such as a CD-ROM, DVD-ROM, or other optical media. All of the above examples may reside on, or be introducible to, the entertainment server 112. In which case, a coupling 204 between the content source 202 and the entertainment server 112 could be a system bus within the entertainment server 112.

Alternately, the content source 202 could be a remote storage medium or broadcasting entity apart from the entertainment server 112. In such case, the coupling 204 could include the cable 114, the satellite 116, an antenna, and/or a network such as the Internet 118.

As shown in FIG. 2, the trick mode optimization module 120 may reside at several locations in the media delivery system 200. Moreover, the media delivery system 200 may employ several trick mode optimization modules 120 at various locations, simultaneously. In general, the trick mode optimization module 120 may reside, or induce its functionality, before any point in media delivery system 200 in which a streaming bottleneck may result. It will be understood that a streaming bottleneck is any situation in which the bit rate of media content being transmitted through media delivery system 200 exceeds the available resources being used to transmit or render the media content. These resources may include, for example, network bandwidth, bus bandwidth, memory capacity (including hard disk capacity), CPU resources, graphics processing unit (GPU) resources, I/O interface resources, decoder resources, and buffer resources.

In perhaps its simplest implementation, the trick mode optimization module 120 may reside on the entertainment server 112. In this configuration, the trick mode optimization module 120 may be used to control the bit rate of media content being streamed from the entertainment server 112 to the home network device 122 over network 124 as well as the bit rate of media content being handled by the resources of the entertainment server 112, such as the hard disk, the CPU and the GPU of the entertainment server 112.

It is also possible for the trick mode optimization module 120 to reside outside of the entertainment server 112. In one exemplary implementation, the trick mode optimization module 120 may reside at the content source 202, or between the content source 202 and the entertainment server 112 such as on an access point. In such a configuration, the trick mode optimization module 120 could be used to control the bit rate of media content being streamed over the coupling 204 between the content source 202 and the entertainment server 112. Additionally, in this configuration the trick mode optimization module 120 could also be used to control the bit rate of media content being streamed between the entertainment server 112 and the decoder 204 over network 124.

Moreover, if the trick mode optimization module 120 resides on or before the content source 202, the trick mode optimization module 120 may be used to control the bit rate of media content being handled by the resources of the content source 202, such as the memory resources, the bus resources, and the CPU and GPU resources of the content source 202—if such resources exist.

In another exemplary embodiment, the trick mode optimization module 120 may reside between the entertainment server 112 and the home network device 122—such as on an access point. In such a configuration, the trick mode optimization module 120 could be used to control the bit rate of media content being streamed over network 124 between the entertainment server 112 and the home network device 122. Additionally, the trick mode optimization module 120 in such a configuration could be used to control the bit rate of media content being handled by the resources of the home network device 122, such as memory resources, bus resources, decoder resources, buffer resources, I/O interface resources, and CPU and GPU resources of the home network device 122.

In yet another exemplary embodiment, the trick mode optimization module 120 could reside on the home network device 122. In such a configuration, the trick mode optimization module 120 could be used to control the bit rate of media content being handled by the resources of the home network device 122, such as the memory resources, the bus resources, the decoder resources, buffer resources, I/O interface resources, and the CPU and GPU resources of the home network device 122.

In addition, as mentioned above, it is also possible to use several trick mode optimization modules 120 simultaneously. For example, one trick mode optimization module 120 could be located on the content source 202 in order to control the bit rate of media content being streamed over the coupling 204 between the content source 202 and the entertainment server 112. Simultaneously, another trick mode optimization module 120 residing on the entertainment server 112 could be used to control the bit rate of media content being streamed over network 124 between the entertainment server 112 and the home network device 122.

In order to avoid a streaming bottleneck, each trick mode optimization module 120 may monitor the resources of the media delivery system 200 and collect and review resource statistics 206 including information regarding, for example, available network bandwidth, available bus resources, available memory, available CPU speed and capacity, available GPU speed and capacity, available decoder speed and capacity, available I/O interface capacity, and available buffer capacity. By reviewing such resource statistics 206, each trick mode optimization module 120 may take appropriate action to reduce the bit rate of the media content being streamed to a level, at or below, that which can effectively be handled by the available resources of media delivery system 200, thus preventing streaming bottlenecks.

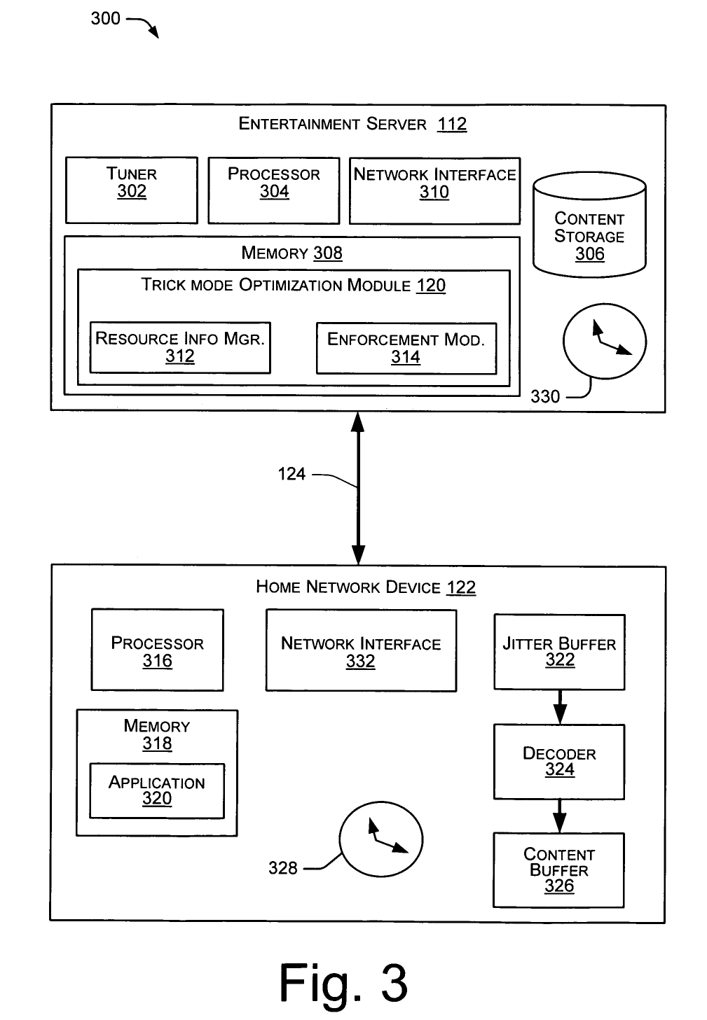

FIG. 3 shows an exemplary architecture 300 suitable for delivering media content to the home network device 122 from the entertainment server 112. In FIG. 3, the trick mode optimization module 120 is illustrated as residing on the entertainment server 112. As noted above, however, it will be understood that the trick mode optimization module 120 need not be hosted on the entertainment server 112. For example, the trick mode optimization module 120 could also be hosted on the content source 202, the home network device 122, an access point, or any other electronic device or storage medium communicatively coupled to a path along which media content is conveyed on its way from the content source 202 to the home network device 122.

The entertainment server 112 may include one or more tuners 302, one or more processors 304, a content storage 306 (which may or may not be the same as the content source 202 in FIG. 2), memory 308, and one or more network interfaces 310. As noted above, the tuner(s) 302 may be configured to receive media content via sources such as an antenna, cable 114, satellite 116, or the Internet 118. The media content may be received in digital form, or it may be received in analog form and converted to digital form at any of the one or more tuners 302 or by the one or more microprocessors 304 residing on the entertainment server 112. Media content either processed and/or received (from another source) may be stored in the content storage 306. FIG. 3 shows the content storage 306 as being separate from memory 308. It will be understood, however, that content storage 306 may also be part of memory 308.

The network interface(s) 310 may enable the entertainment server 112 to send and receive commands and media content among a multitude of devices communicatively coupled to the network 124. For example, in the event both the entertainment server 112 and the home network device 122 are connected to the network 124, the network interface 310 may be used to deliver content such as live HD television content from the entertainment server 112 over the network 124 to the home network device 122 in real-time with media transport functionality (i.e. the home network device 122 may render the media content and the user may be afforded functions such as pause, play, seek, fast forward, rewind, etc).

Requests from the home network device 122 for media content available on, or through, the entertainment server 112 may also be routed from the home network device 122 to the entertainment server 112 via network 124. In general, it will be understood that the network 124 is intended to represent any of a variety of conventional network topologies and types (including optical, wired and/or wireless networks), employing any of a variety of conventional network protocols (including public and/or proprietary protocols). As discussed above, network 124 may include, for example, a home network, a corporate network, the Internet, or IEEE 1394, as well as possibly at least portions of one or more local area networks (LANs) and/or wide area networks (WANs).

The entertainment server 112 can make any of a variety of data or content available for delivery to the home network device 122, including content such as audio, video, text, images, animation, and the like. In one implementation, this content may be streamed from the entertainment server 112 to the home network device 122. The terms “streamed” or “streaming” are used to indicate that the content is provided over the network 124 to the home network device 122 and that playback of the content can begin prior to the content being delivered in its entirety. The content may be publicly available or alternatively restricted (e.g., restricted to only certain users, available only if an appropriate fee is paid, restricted to users having access to a particular network, etc.). Additionally, the content may be “on-demand” (e.g., pre-recorded, stored content of a known size) or alternatively it may include a live “broadcast” (e.g., having no known size, such as a digital representation of a concert being captured as the concert is performed and made available for streaming shortly after capture).

Memory 308 stores programs executed on the processor(s) 304 and data generated during their execution. Memory 308 may include volatile media, non-volatile media, removable media, and non-removable media. It will be understood that volatile memory may include computer-readable media such as random access memory (RAM), and non volatile memory may include read only memory (ROM). A basic input/output system (BIOS), containing the basic routines that help to transfer information between elements within the entertainment server 112, such as during start-up, may also be stored in ROM. RAM typically contains data and/or program modules that are immediately accessible to and/or presently operated on by the one or more processors 304.

As discussed above, the entertainment server 112 may also include other removable/non-removable, volatile/non-volatile computer storage media such as a hard disk drive for reading from and writing to a non-removable, non-volatile magnetic media, a magnetic disk drive for reading from and writing to a removable, non-volatile magnetic disk (e.g., a “floppy disk”), and an optical disk drive for reading from and/or writing to a removable, non-volatile optical disk such as a CD-ROM, DVD-ROM, or other optical media. The hard disk drive, magnetic disk drive, and optical disk drive may be each connected to a system bus (discussed more fully below) by one or more data media interfaces. Alternatively, the hard disk drive, magnetic disk drive, and optical disk drive may be connected to the system bus by one or more interfaces.

The disk drives and their associated computer-readable media provide non-volatile storage of media content, computer readable instructions, data structures, program modules, and other data for the entertainment server 112. In addition to including a hard disk, a removable magnetic disk, and a removable optical disk, as discussed above, the memory 308 may also include other types of computer-readable media, which may store data that is accessible by a computer, like magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the memory 308 including, by way of example, an operating system, one or more application programs, other program modules, and program data. One such application could be the trick mode optimization module 120, which includes a resource information manager 312, and an enforcement module 314. The trick mode optimization module 120 may be executed on processor(s) 304, and can be used to avoid overloading available resources being used to transmit or render media content when various trick mode functions, such as fast forward and rewind are activated during the streaming of media content from the entertainment server 112 to the home entertainment device 122. In addition to being implemented, for example, as a software module stored in memory 308, the trick mode optimization module 120 may also reside, for example, in firmware. Moreover, even though the resource information manager 312, and the enforcement module 314 are shown in FIG. 3 as residing inside the trick mode optimization module 120, either or both of these elements may exist separate and as stand alone applications. Generally, however, the enforcement module 314 is placed before areas in which a streaming bottleneck is likely to occur, while the information manager 312 may reside anywhere within media delivery system 200. More discussion of the nature and function of the trick mode optimization module 120 will be given below.

The entertainment server 112 may also include a system bus (not shown for the sake of graphic clarity) to communicatively couple the one or more tuners 302, the one or more processors 304, the network interface 310, and the memory 308 to one another. The system bus may include one or more of any of several types of bus structures, including a memory bus or memory controller, a peripheral bus, an accelerated graphics port, and a processor or local bus using any of a variety of bus architectures.

A user may enter commands and information into the entertainment server 112 via input devices such as a keyboard, pointing device (e.g., a “mouse”), microphone, joystick, game pad, satellite dish, serial port, scanner, and/or the like. These and other input devices may be connected to the one or more processors 304 via input/output (I/O) interfaces that are coupled to the system bus. Additionally, input devices may also be connected by other interface and bus structures, such as a parallel port, game port, universal serial bus (USB) or any other connection included in the network interface 310.

In a networked environment, program modules depicted and discussed above in conjunction with the entertainment server 112 or portions thereof, may be stored in a remote memory storage device. By way of example, remote application programs may reside on a memory device of a remote computer communicatively coupled to network 124. For purposes of illustration, application programs and other executable program components, such as the operating system and the trick mode optimization module 120, may reside at various times in different storage components of the entertainment server 112, or of a remote computer, and may be executed by one of the at least one processors 304 of the entertainment server 112 or of the remote computer.

The exemplary home network device 122 may include one or more processors 316, and a memory 318. Memory 318 may include one or more applications 320 that consume or use media content received from sources such as the entertainment server 112. A jitter buffer 322 may receive and buffer data packets streamed to the home network device 122 from the entertainment server 112. Because of certain transmission issues including limited bandwidth and inconsistent streaming of content that lead to underflow and overflow situations, it is desirable to keep some content (i.e., data packets) in the jitter buffer 322 in order to avoid glitches or breaks in streamed content, particularly when audio/video content is being streamed.

In the implementation shown in FIG. 3, a decoder 324 may receive encoded data packets from the jitter buffer 322, and decode the data packets. In other implementations, a pre-decoder buffer (i.e., buffer placed before the decoder 324) may be incorporated. In certain cases, compressed data packets may be sent to and received by the home network device 122. For such cases, the home network device 122 may be implemented with a component that decompresses the data packets, where the component may or may not be part of decoder 324. Decompressed and decoded data packets may then be received and stored in a content buffer 326.

The content buffer 326 may also include one or more buffers to store specific types of content. For example, there could be a separate video buffer to store video content, and a separate audio buffer to store audio content. Furthermore, the jitter buffer 322 could include separate buffers to store audio and video content.

The home network device 122 may also include a clock 328 to differentiate between data packets based on unique time stamps included in each particular data packet. In other words, clock 328 may be used to play the data packets at the correct speed. In general, the data packets are played by sorting them based on time stamps that are included in the data packets and provided or issued by clock 330 of the entertainment server 112.

A user may enter commands and information into the home network device 122 via input devices such as a remote control, keyboard, pointing device (e.g., a “mouse”), microphone, joystick, game pad, satellite dish, serial port, scanner, and/or the like. These and other input devices may be connected to the one or more processors 316 via input/output (I/O) interfaces that are coupled to a system bus. Additionally, input devices may also be connected by other interface and bus structures, such as a parallel port, game port, universal serial bus (USB) or any other connection included in a network interface 332.

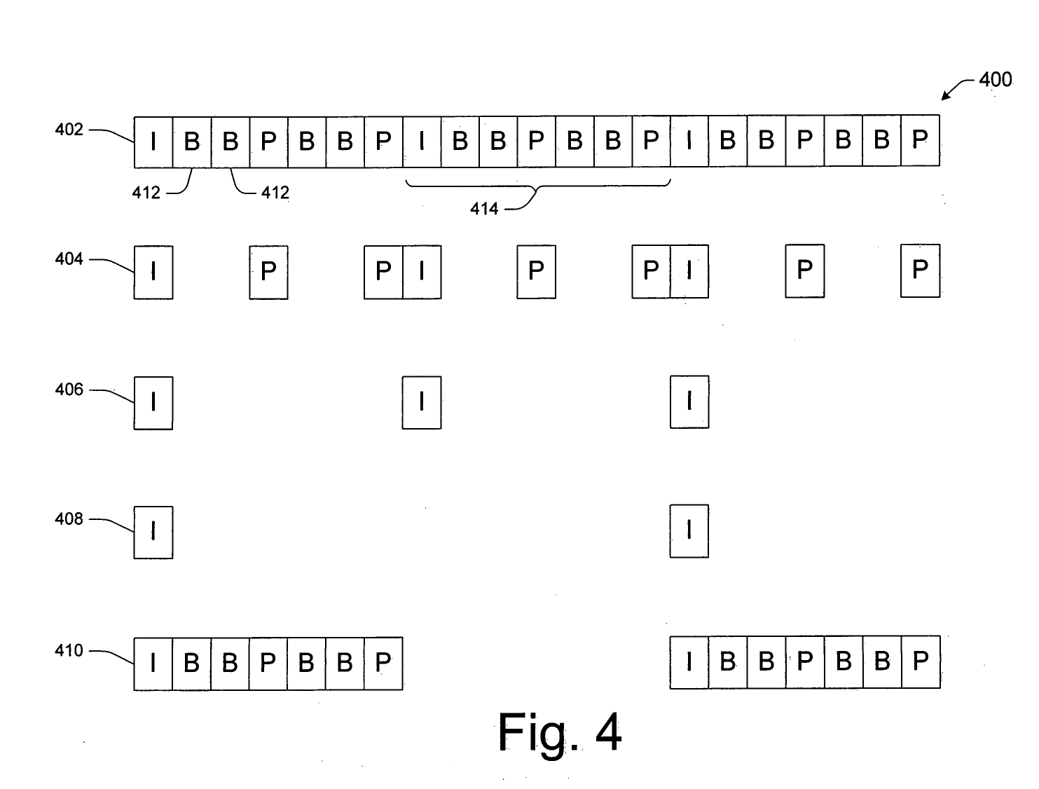

FIG. 4 shows a stream of frames 402 along with several examples of altered streams 404, 406, 408, 410 which might be created through use of the trick mode optimization module 120. In FIG. 4, the stream of frames 402 contains bi-directionally predicted B-frames 412 such as might be found in video formats like MPEG-1, MPEG-2 and WMV. It will be understood, however, that in addition to MPEG-1, MPEG-2 and WMV formats, other formats—including non bi-directionally predicted formats—may also be used with the trick mode optimization module 120. In addition, the use of B-frames, P-frames and I-frames in FIG. 4 is for illustrative purposes only. It will be understood that the trick mode optimization module 120 may be used with streams having delta frames other than B-frames and P-frames, and key frames other than I-frames.

In operation, in order to stream media content from the content source 202 to the home network device 122, a stream of frames 402 including media content information is delivered from the content source 202 to the home network device 122 via the entertainment server 112. During this streaming operation, a user may instigate a trick mode such as fast forward or rewind, which may significantly increase the bit rate at which the stream 402 is delivered from the content source 202 to the home network device 122. For example, if during regular single-speed playback the stream 402 has a bit rate of 2 Mbps, when a user desires to fast forward the stream 402 at a speed of 10×, the stream's flow rate will increase to a trick mode bit rate of 20 Mbps.

### Information Manager

When a user instigates a trick mode, the resource information manager 312 in the trick mode optimization module 120 will actively monitor resource utilization in the media delivery system 200. As discussed above, the resources monitored may include available memory capacity (including hard disk capacity), available bus bandwidth, and available CPU and GPU resources of the content source 202, the entertainment server 112, the home network device 122, and any other devices used to transmit the stream 402 from the content source 202 to the home network device 122. In addition, the available speed and capacity of the decoder 324, as well as capacity of buffers, and information concerning network resources, such as available bandwidth of the network 124, coupling 204, and any other networks or couplings used to transmit the stream 402 from the content source 202 to the home network device 122 may be monitored by the information manager 312.

In one exemplary implementation, the resource information manager 312 may collect the statistics 206 regarding the resources once the trick mode is instigated. In another exemplary implementation, the resource information manager 312 may constantly monitor the statistics 206 regardless of whether a trick mode is instigated or not.

Once the resource information manager 312 possesses the statistics 206 regarding available resources, it may compare the statistics 206 against the resources required to facilitate the streaming of the stream 402. If the flow rate of the stream 402 during the trick mode may be handled by the available resources, then there is no danger of over saturation of any of the resources of media delivery system 200, and no intervention is necessary. Alternately, however, if the increased flow rate of the stream 402 during the trick mode requires more capacity than is indicated as available by the received resource statistics 206—or if the flow rate of the stream requires resources approaching those available as indicated by the received resource statistics 206—then a danger exists that one or more resources will be overloaded. When this occurs, unexpected and undesirable behavior can result in disruptions encountered at the content source 202, the coupling 204, the entertainment server 112, the network 124, and/or the home network device 122.

The trick mode optimization module 120, resource information manager 312 and enforcement module 314 exist to avert such unexpected and undesirable behavior by adaptively decreasing the flow rate of the stream 402.

### Enforcement Module

Once the resource information manager 312 has examined the statistics 206 on the available resources, and resource information manager 312 has determined that there is a danger of over saturation, the resource information manager 312 may mandate a slow down of the stream 402 to be carried out by the enforcement module 314. The information manager 312 has several possible strategies at its disposal which will be discussed in more detail below. By calculating flow rates resulting from each of these possible strategies, the information manager 312 may select an appropriate strategy resulting in a flow rate just low enough to be accommodated safely by the resources of the media delivery system 200, while maximizing the amount of media content being streamed in order to render the best possible user experience.

For example, in the event that the stream 402 is in a format having bi-directionally predicted frames, the information manager 312 can direct the enforcement module 314 to drop all of the B frames in the stream 402, resulting in a new stream 404, with a decreased flow rate.

B-frames typically carry the smallest amount of information of all the frame types used in a format having bi-directionally predicted frames. For example, in one possible implementation I-frames may have a size of approximately 100 kb, while P-frames may have a size of 50 kb, and B-frames may have a size of approximately 25 kb. Moreover, assuming an exemplary playback speed for such a stream 402 is 7 frames per second, in normal playback mode the stream 402 may have a flow rate of (1×100)+(2×50)+(4×25)=300 kbps. If a trick mode is instigated, however—such as a user fast forwarding the stream 402 at 3×—the flow rate of the stream 402 may increase to (3×100)+(6×50)+(12×25)=900 kbps.

By dropping the B-frames, the flow rate of the new stream 404 in the fast forward mode can be reduced considerably. In the example above, the flow rate of stream 404 without B-frames is only (3×100)+(6×50)=600 kbps.

If the reduced flow rate of stream 404 is still too high to be safely accommodated by the resources of media delivery system 200, the information manager 312 may resort to a more aggressive strategy and direct the enforcement module 314 to remove both the B-frames and the P-frames from stream 402 to arrive at stream 406. Returning to the example above, the flow rate of stream 406 at a fast forward speed of 3× is (100×3)=300 kbps. This represents a significant reduction from the 900 kbps flow rate of stream 402.

In some instances, however, this reduction may not be enough to allow the media content to be safely accommodated by the resources of the media delivery system 200. In this event, the information manager 312 may direct the enforcement module 314 to reduce the flow rate of the media content even further by removing the B-frames, P-frames, and selected I-frames (key frames) from stream 402 to arrive at stream 408. According to the example above, if one of three I-frames is removed from stream 402, the flow rate of stream 408 at a fast forward speed of 3× will be (100×2)=200 kbps. If necessary, the information manager 312 may direct the enforcement module 314 to drop even more I-frames to decrease the flow rate of the stream of media content even further to reach a level which can safely be accommodated by the resources of media delivery system 200.

As mentioned above, the trick mode optimization module 120 may also be used with formats not containing bi-directionally predicted frames. In such case no B-frames will be included in the stream of media content 402. Thus the information manager may follow the same course of action described above, with the exception that the first strategy mentioned above (dropping B-frames) will not be at its disposal.

In another possible strategy, the information manger 312 may direct the enforcement module 314 to decrease the flow rate of stream 402 by selectively dropping entire sequences between key frames, such as sequence 414, resulting in a reduced stream 410. Following the example above, the flow rate of stream 410 at a fast forward speed of 3× is (2×100)+(4×50)+(8×25)=600 kbps. If, however, the 600 kbps flow rate of stream 410 cannot safely be accommodated by the resources of the media delivery system 200, the information manager 312 may further lower the flow rate of the media content by directing the enforcement module 314 to drop more sequences 414 from stream 402.

The information manager 312 may also mix strategies to find an optimal solution in which the lowered flow rate is maximized such that it can be used to render the highest possible quality of user experience while still being low enough to be safely accommodated by the resources of media delivery system 200. For example, the information manager 312 may direct the enforcement module 314 to drop both selected sequences 414, as well as B-frames from the remaining sequences in the stream. Alternately the information manager 312 may direct the enforcement module 314 to drop selected sequences 414, as well as B-frames and P-frames from the remaining sequences of the stream.

It will also be understood that the information manager 312 may consider the capabilities of the decoder 324 being used to render the media content when the resource information manager 312 reviews strategy options. For example, if the decoder 324 does not support B-frames and P-frames when a reverse trick mode is activated, then the information manager 312 may instruct the enforcement module to drop all B-frames and P-frames, so that only I-frames are sent to the decoder 324 when a user selects a reverse trick mode.

### Trick Mode Optimization Method

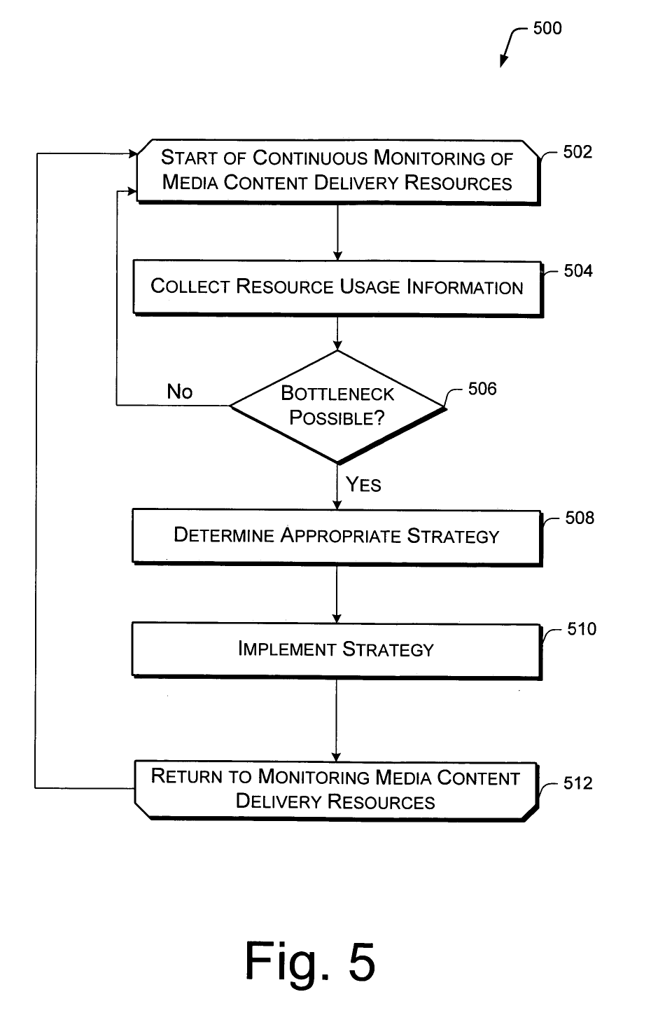

Another aspect of optimizing the streaming of media content from a content source 202 to a home network device 122 while a trick mode is activated is shown in FIG. 5 which illustrates an exemplary method 500 performed by the trick mode optimization module 120. For ease of understanding, the method 500 is delineated as separate steps represented as independent blocks in FIG. 5; however, these separately delineated steps should not be construed as necessarily order dependent in their performance. Additionally, for discussion purposes, the method 500 is described with reference to elements in FIGS. 1-4. Also, as with FIG. 4 above, it will be understood that the use of B-frames, P-frames and I-frames in the explanation of FIG. 5 is for illustrative purposes only. Both the method 500 and the trick mode optimization module 120 may be used with streams having delta frames other than B-frames and P-frames, and key frames other than I-frames.

The method 500 continuously monitors the status of media content delivery resources at a block 502. This may be accomplished by continuously collecting information regarding the availability of media delivery resources, including, for example, CPU resources, GPU resources, bus resources, buffer resources, decoder resources, memory resources (including hard disk resources), and (I/O) interface resources of the content source 202, the entertainment server 112, the home network device 122 and any other device on the path over which the media content is streamed from the content source 202 to the home media device 122 (block 504). In addition, the available resources of the network 124 may also be monitored. In one exemplary implementation, the monitoring of resources may be performed by the resource information manager 312. Additionally, in one possible implementation, the continuous monitoring of resources of block 502 starts once a trick mode is initiated by a user, and ends once the trick mode is deactivated. In another possible implementation, the media content delivery resources are continuously monitored regardless of the activation or deactivation of a trick mode.

Once collected, the resource availability information may be compared against an estimate of the resources which will be required to safely accommodate a flow rate of media content desired by a user during a trick mode (block 506). For example, if a trick mode has been activated, the format of the media content and the desired speed of the trick mode may be used to estimate an expected bit rate of the streaming media content which will be sustained during the trick mode's activation. This estimated bit rate may then be compared against the available resources collected in block 504 to determine if a danger exists that a bottleneck will be created due to the demands of the expected bit rate outstripping the available media delivery resources (block 506). In one exemplary implementation, this examination may be done by the resource information manager 312. In addition, the estimated bit rate may be compared against the total available the available media delivery resources data to see if any of the available media delivery resources will be burdened to a level close to saturation.

If no conflicts exist, and there is no danger of over saturation—or if no danger exists of placing any of the resources of the media delivery system 200 precariously close to saturation—then no intervention is necessary, and the method 500 returns to block 502 (i.e. the “no” branch from block 506).

Alternately, however, if any of the resources of the media delivery system 200 are found to be in danger of being saturated (i.e. the “yes” branch from block 506), the method 500 may examine possible strategies for reducing the bit rate of the media content stream to a value which can be safely accommodated by the available media delivery resources (block 508). These strategies may include dropping the B-frames from the stream of media content, or dropping both the B-frames and P-frames from the stream of media content. Moreover, B-Frames, P-frames and selected I-frames may be removed from the stream of media content. Alternately, entire sequences 414 of frames between I-frames may be removed. Moreover, a combination of the preceding strategies may be employed. For example, selected sequences 414 may be removed, and additional frames (B-frames, or B-frames and P-frames) may be removed from the remaining sequences of the streaming media content. All of the above strategies may also be employed with media content in formats not containing bi-directionally predicted frames. In such a case, no B-frames exist however, so none can be removed from the stream of media content.

In addition to examining the possible strategies mentioned above, the method 400 may also consider the capabilities of the decoder 324 being used to render the media content. For example, if the decoder 324 does not support B-frames and P-frames when a reverse trick mode is activated, then it will be determined that only I-frames should be sent to the decoder 324 when such a reverse trick mode is activated.

Of all the strategies possible, an appropriate strategy to be chosen is one which results in a flow rate just low enough to be accommodated safely by the resources of the media delivery system 200, while maximizing the amount of media content being streamed in order to render the best possible user experience. Once such a strategy is located, it may be implemented on the stream of media content (block 510). As a result, the bit rate of the streaming media content can be reduced to a level which can be safely accommodated by the available media delivery resources and the danger of a bottleneck will be averted. In one exemplary implementation, the strategy may be implemented by the enforcement module 314. Once the strategy has been successfully initiated (blocks 510, 512) the method 500 may then return to block 502 and resume continuously monitoring the resources of the media delivery system 200.

It will be understood that once the trick mode which triggered method 500 is deactivated, the strategy instigated at block 510 may be discontinued and the media content stream may be reinstituted to its original playback speed with its original form (i.e. without any frames being dropped by method 500). It will also be understood that in one implementation, once the trick mode is deactivated, the method 500 will discontinue monitoring the media delivery resources, and will not start up again until another trick mode is activated.

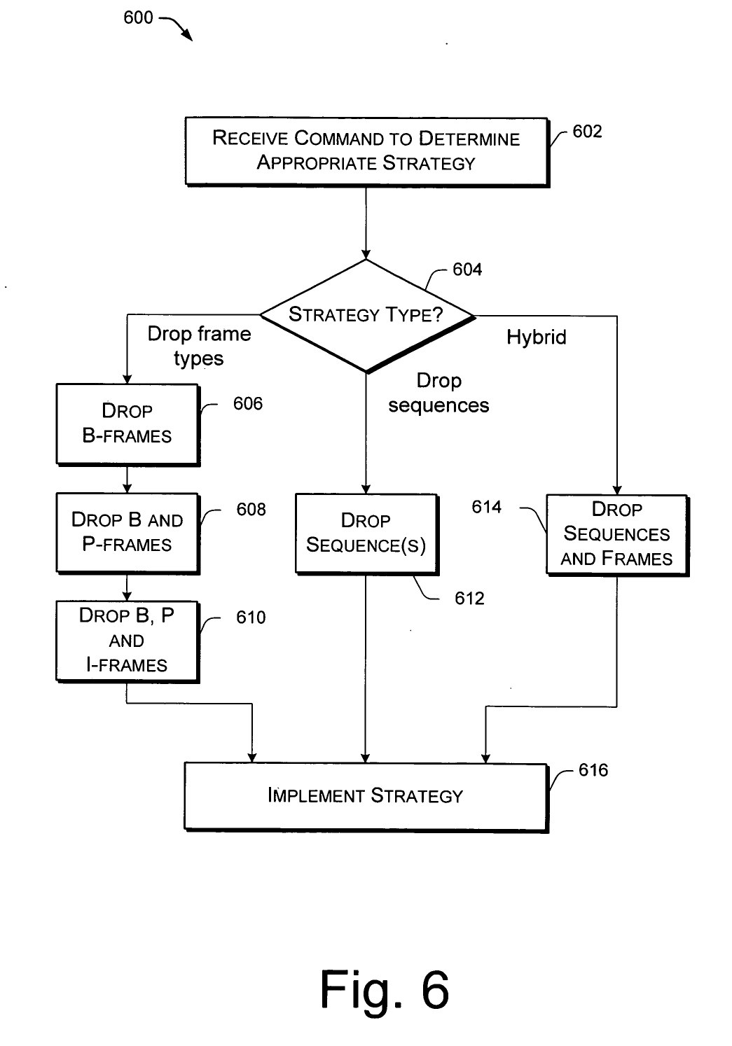

Another aspect of determining the desired strategy is shown in FIG. 6, which illustrates an exemplary method 600 which may be performed by the information manager 312. For ease of understanding, the method 600 is delineated as separate steps represented as independent blocks in FIG. 6; however, these separately delineated steps should not be construed as necessarily order dependent in their performance. Additionally, for discussion purposes, the method 600 is described with reference to elements in FIGS. 1-4. Moreover, as with FIGS. 4 and 5 above, the use of B-frames, P-frames and I-frames in the explanation of FIG. 6 is for illustrative purposes only. It will be understood that the both the method 600 and the information manager 312 may be used with streams having delta frames other than B-frames and P-frames, and key frames other than I-frames.

Once it has been determined that the increased flow rate resulting from the instigation of a trick mode will overburden the resources of media delivery system 200, a command will be issued to determine an appropriate strategy to decrease the bit fate of the stream of media content. When this command is received (block 602) the method 600 begins to evaluate several possible lines of strategy which may be pursued (block 604).

One possible line of strategy includes the dropping of frame types (i.e. the “Drop frame types” branch from block 604). For example, in the event that the media content is in a format having bi-directionally predicted frames, all of the B frames in the stream of media content may be dropped (block 606).

B-frames typically carry the smallest amount of information of all the frame types used in a format having bi-directionally predicted frames. By dropping the B-frames, the flow rate of the stream of media content in the trick mode can be reduced considerably.

However, if the reduced flow rate of the stream of media content is still too high to be safely accommodated by the resources of media delivery system 200, the method 600 may pursue a more aggressive strategy and remove both the B-frames and the P-frames from the stream of media content (block 608). P-frames are intermediate in size relative to B-frames and I-frames, and so their removal can result in considerable decreases in bit rate.

If this still doesn't constitute a suitable strategy to reduce the flow rate of the stream of media content to a rate which can be safely accommodated by the resources of the media delivery system 200, the method 600 may to reduce the flow rate of the media content even further by removing the B-frames, P-frames, and selected I-frames (key frames) from stream of media content (block 610).

The method 600 may also be used with formats not containing bi-directionally predicted frames. In such case no B-frames will be included in the stream of media content. Thus with the exception of dropping the B-frames (block 606) the other two drop frame type strategies (block 608, 610) may be pursued in a modified form in which no B-frames are dropped (i.e. dropping P-frames, and dropping P-frames and selected I-frames).

Another possible line of strategy involves dropping sequences of frames between I-frames from the stream of media content (i.e. the “Drop sequences” branch from block 604). Under such a strategy the method 600 may selectively drop entire sequences between I-frames, such as sequence 414, resulting in a stream of media content with a reduced bit rate (block 612). Sequences 414 may be dropped in proportion to how much the bit rate of the stream of content must be reduced. That is, if it is desired to reduce the bit rate of the stream of media content more drastically, then a higher proportion of sequences 414 may be dropped.

Yet another possible line of strategy which may be pursued includes the hybrid line (i.e. the “Hybrid” branch from block 604). Under such a strategy, the method 600 may mix the Drop frame type strategies (blocks 606-610) and the drop sequence strategies (block 612) to arrive at a strategy that incorporates elements of both strategies (block 614). For example, the method 600 may drop selected sequences 414, as well as B-frames from the remaining sequences in the stream of media content. Alternately the method may drop selected sequences 414, as well as B-frames and P-frames from the remaining sequences of the stream of media content. In this manner, the method may alter the amount of sequences dropped, and fine tune the resulting bit rate of the stream of media content by dropping B-frames and potentially also P-frames.

Additionally, the method 600 may also consider the capabilities of the decoder 324 being used to render the stream of media content. For example, if the decoder 324 does not support B-frames and P-frames when a reverse trick mode is activated, the method 600 can drop all B-frames and P-frames, so that only I-frames are sent to the decoder 324 during a reverse operation.

The goal of the above strategies is to find an optimal solution in which the lowered flow rate of the stream of media content is maximized such that it can be used to render the highest possible quality of user experience while still being low enough to safely be accommodated by the resources of media delivery system 200. Once such a strategy is located which will offer such as result, the strategy is implemented by method 600 and the bit rate of the stream of media content is reduced accordingly (block 616).

It will be understood that the strategy implemented in block 616 may be discontinued when the trick mode is deactivated, allowing the stream of media content to return to a normal playback rate with a full complement of frame types.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claimed invention.

1. A method, implementable by a computer system, comprising:
monitoring a current state of a media delivery system while media content is being streamed over the media delivery system at a trick mode bit rate;
detecting in the media delivery system a resource which cannot accommodate the trick mode bit rate;
removing selected portions of the media content prior to the media content reaching the resource to reduce the trick mode bit rate to a reduced bit rate that can be accommodated by the resource.

2. The method of claim 1, wherein said monitoring comprises at least one of reviewing data regarding at least one of capabilities and available resources of a CPU, reviewing data regarding at least one of capabilities and available resources of a GPU, reviewing data regarding at least one of capabilities and available resources of media system memory, reviewing data regarding at least one of capabilities and available resources of a hard disk on a PC, reviewing data regarding at least one of capabilities and available resources of an I/O interface, reviewing data regarding at least one of capabilities and available resources of an I/O interface hard disk, reviewing data regarding at least one of capabilities and available resources of a decoder, reviewing data regarding at least one of capabilities and available resources of a buffer, reviewing data regarding at least one of capabilities and available resources of a bus, and reviewing data regarding at least one of capabilities and available resources of a network.

3. The method of claim 1, wherein a trick mode comprises one of rewinding the media content and fast forwarding the media content.

4. The method of claim 1, wherein the media content is formatted according to at least one format from a group of formats comprising MPEG 1, MPEG 2, MPEG 4, and WMV.

5. The method of claim 1, wherein removing selected portions from the media content being streamed comprises dropping one of delta frames, key frames, B-frames, P-frames, and I-frames from the media content.

6. The method of claim 1, wherein removing selected portions from the media content being streamed comprises eliminating selected frame sequences between key frames from the media content.

7. The method of claim 1, further comprising discontinuing removing frames from the media content once a trick mode is deactivated.

8. The method of claim 1, wherein if the media content has bi-directionally predicted frames, removing selected portions of the media content being streamed comprises iteratively removing a selection of B-frames,
in the event that the removal of the selection of B-frames does not reduce the trick mode bit rate to a bit rate that can be accommodated by the resource, or if the media content does not have bi-directionally predicted frames, removing a selection of P-frames, and
in the event that the removal of the selection of P-frames does not reduce the trick mode bit rate to a bit rate that can be accommodated by the resource, removing a selection of I-frames.

9. A server comprising:
a processor; and
a trick mode optimization module executable on the processor to ascertain a target bit rate that resources used to stream media content can accommodate when the media content is streamed in a trick mode, and to selectively remove portions of the media content when streamed in the trick mode to decrease the bit rate of the streaming media content to the target bit rate.

10. The server of claim 9, wherein the server is one of a home PC, an access point, and a set top box.

11. The server of claim 9, wherein the trick mode optimization module ascertains the target bit rate by reviewing resource capability and availability information from resources comprising at least one of a CPU, a GPU, a network, a computer's memory, a computer's hard disk, an I/O interface, an I/O interface hard disk, a decoder, a buffer, and a bus.

12. The server of claim 9, wherein the trick mode optimization module resides in an operating system.

13. A computer-readable storage medium having computer-readable instructions that, when executed, perform acts comprising:
identifying a resource in a media delivery system which cannot accommodate media content being streamed at a trick mode bit rate by the media delivery system; and
deleting selected portions of the media content to decrease the trick mode bit rate to a bit rate that can be accommodated by the resource.

14. A media delivery system comprising at least one server utilizing the computer-readable instructions of claim 13 to facilitate the delivery of media content during a trick mode while avoiding creation of a bottleneck at a resource.

15. The computer-readable storage medium of claim 13, wherein said identifying comprises collecting information regarding one of capability and availability concerning the resource, and comparing the one of capability and availability information against the trick mode bit rate.

16. The computer-readable storage medium of claim 15, wherein said collecting further comprises obtaining data on one of capability and availability of one of: a CPU, a GPU, a network, a computer's memory, a hard disk, an I/O interface hard disk, an I/O interface, a decoder, a buffer, and a bus.

17. The computer-readable storage medium of claim 13, wherein if the media content has bi-directionally predicted frames, deleting selected portions of the media content comprises deleting a selection of B-frames,
in the event that the deletion of the selection of B-frames does not reduce the trick mode bit rate to a bit rate that can be accommodated by the resource, or if the media content does not have bi-directionally predicted frames, deleting a selection of P-frames, and
in the event that the removal of the selection of P-frames does not reduce the trick mode bit rate to a bit rate that can be accommodated by the resource, deleting a selection of I-frames.

18. The computer-readable storage medium of claim 13, wherein removing frames from the media content being streamed comprises removing select frame sequences between the I-frames from the media content.

19. An operating system comprising the computer-readable instructions of claim 13.

20. An entertainment device comprising a processor and the computer readable storage medium of claim 13, wherein the computer-readable instructions are implemented on the processor.
